(19) United States
(12) Patent Application Publication
(10) Pub. No.: US 2025/0133256 A1
(43) Pub. Date: Apr. 24, 2025

(54) ELECTRONIC DEVICE AND METHOD FOR CONTROLLING THE SAME

(71) Applicant: SAMSUNG ELECTRONICS CO., LTD., Suwon-si Gyeonggi-do (KR)

(72) Inventors: Eunjoo CHO, Suwon-si (KR); Yuri MIN, Suwon-si (KR); Youngah LEE, Suwon-si (KR); Kyunghwa JUNG, Suwon-si (KR); Donghun SHIN, Suwon-si (KR); Woonghee LEE, Suwon-si (KR); Junpyo HONG, Suwon-si (KR)

(73) Assignee: SAMSUNG ELECTRONICS CO., LTD., Suwon-si Gyeonggi-do (KR)

(21) Appl. No.: 18/985,535

(22) Filed: Dec. 18, 2024

Related U.S. Application Data
(63) Continuation of application No. PCT/KR2024/095977, filed on Aug. 1, 2024.

(30) Foreign Application Priority Data
Oct. 19, 2023 (KR) 10-2023-0140222

(51) Int. Cl. H04N 21/422; H04N 21/431

(52) U.S. Cl. CPC H04N 21/42226; H04N 21/4312

(57) ABSTRACT

Provided are an electronic device and a method for controlling the same. The electronic device includes a display, a memory configured to store at least one instruction, and a processor configured to, by executing the at least one instruction, acquire, while pairing the electronic device with an external input device is performed, information about the external input device from the external input device, acquire button mapping information between an existing input device of the electronic device and the external input device based on the information about the external input device, control the display to display an image corresponding to the external input device acquired based on the information about the external input device, and control the display to display the button mapping information using the image corresponding to the external input device displayed on the display.

### CROSS-REFERENCE TO RELATED APPLICATION(S)

This application is a continuation application of International application No. PCT/KR2024/095977, filed on Aug. 1, 2024, and claims the benefit of Korean patent application number 10-2023-0140222, filed on Oct. 19, 2023, the disclosures of which are incorporated by reference herein in their entireties.

### BACKGROUND

### Field

The disclosure relates to an electronic device and a method for controlling the same, and more particularly, to an electronic device that performs a function based on a control signal input through an external input device and a method for controlling the same.

### Description of the Related Art

Recently, electronic devices, such as TVs, may be controlled using existing input devices (e.g., remote controllers, etc.), as well as external input devices (e.g., keyboards, remote controllers, and remote controllers of other electronic devices, etc.) other than existing input devices. In particular, if the existing input device for controlling the electronic device is lost or the existing input device is broken, a situation in which the electronic device is controlled using an external input device may arise.

However, in the related art, when controlling an electronic device using an external input device, it may be difficult to determine how the buttons of the external input device are mapped to the functions of the electronic device.

### SUMMARY

According to an embodiment of the disclosure, an electronic device includes: a display, a memory configured to store at least one instruction, and a processor configured to, by executing the at least one instruction, acquire, while pairing the electronic device with an external input device is performed, information about the external input device from the external input device, acquire button mapping information between an existing input device of the electronic device and the external input device based on the information about the external input device, control the display to display an image corresponding to the external input device acquired based on the information about the external input device, and control the display to display the button mapping information using the image corresponding to the external input device displayed on the display.

The processor may be configured to, by executing the at least one instruction, acquire button information of the external input device using information about the external input device, and acquire the button mapping information by comparing the button information of the external input device with button information of the existing input device.

The information about the external input device may include at least one of a device name and a device type of the external input device, and the processor may be configured to, by executing the at least one instruction, acquire the button information of the external input device by searching a pre-built database using at least one of the device name and the device type of the external input device or through a web search.

The button information of the external input device may include information about at least one of a layout of buttons included in the external input device, functions of buttons, button operation methods, number of buttons, and signals corresponding to buttons, and the processor may be configured to, by executing the at least one instruction, map buttons that perform a same function or have a same operation method among the buttons included in the external input device and buttons included in the existing input device.

The processor may be configured to, by executing the at least one instruction, map a plurality of operation methods for the buttons included in the external input device to the buttons included in the existing input device, based on a number of the buttons included in the external input device being smaller than the number of buttons included in the existing input device.

The processor may be configured to, by executing the at least one instruction, generate the image corresponding to the external input device using an image of the external input device and the layout of the buttons included in the external input device.

The processor may be configured to, by executing the at least one instruction, receive, based on a button selected from buttons included in the external input device while the image corresponding to the external input device is displayed, a signal corresponding to the selected button from the external input device, and the display button mapping information may include a guide message to explain a function of the selected button on the image corresponding to the external input device based on the received signal.

The processor may be configured to, by executing the at least one instruction, control the display to display the image corresponding to the external input device and an image of the existing input device, and control the display to display the button mapping information by connecting mapped buttons among buttons included in the image corresponding to the external input device and buttons included in the image of the existing input device.

The displayed button mapping information may include a guide message to explain functions of buttons included in the image corresponding to the external input device, together with the image corresponding to the external input device.

The processor may be configured to, by executing the at least one instruction, acquire the button mapping information by mapping a function not provided by the existing input device to a button of the external input device based on a user input.

According to an embodiment of the disclosure, a method for controlling an electronic device may include acquiring, while pairing the electronic device with an external input device is performed, information about the external input device from the external input device, acquiring button mapping information between an existing input device of the electronic device and the external input device based on the information about the external input device, displaying an image corresponding to the external input device acquired based on the information about the external input device, and displaying the button mapping information using the displayed image corresponding to the external input device.

The acquiring of the button mapping information may include acquiring button information of the external input device using information about the external input device and acquiring the button mapping information by comparing the button information of the external input device with button information of the existing input device.

The information about the external input device may include at least one of a device name and a device type of the external input device, and the acquiring of the button mapping information may include acquiring the button information of the external input device by searching a pre-built database using at least one of the device name and the device type of the external input device or through a web search.

The button information of the external input device may include information about at least one of a layout of buttons included in the external input device, functions of buttons, button operation methods, number of buttons, and signals corresponding to buttons, and the acquiring of the button mapping information may include mapping buttons that perform a same function or buttons having a same operation method among the buttons included in the external input device and buttons included in the existing input device.

The acquiring of the button mapping information may include mapping a plurality of operation methods for the buttons included in the external input device to the buttons included in the existing input device, based on a number of the buttons included in the external input device being smaller than a number of buttons included in the existing input device.

The method may further include generating an image corresponding to the external input device using the image of the external input device and the layout of the buttons included in the external input device.

The displaying of the button mapping information may include receiving, based on a button selected from the buttons included in the external input device while the image corresponding to the external input device is displayed, a signal corresponding to the selected button, and displaying a guide message to explain a function of the selected button on the image corresponding to the external input device based on the received signal.

The displaying of the image corresponding to the external input device may include displaying the image corresponding to the external input device and an image of the existing input device, and the displaying of the button mapping information may include displaying the button mapping information by connecting mapped buttons among buttons included in the image corresponding to the external input device and buttons included in the image of the existing input device.

The displaying of the button mapping information may include displaying a guide message to explain functions of buttons included in the image corresponding to the external input device, together with the image corresponding to the external input device.

The acquiring of the button mapping information may include acquiring the button mapping information by mapping a function not provided by the existing input device to a button of the external input device based on a user input.

### BRIEF DESCRIPTION OF THE DRAWINGS

FIG. 1 is a diagram illustrating a system including an electronic device and a plurality of input devices for controlling the electronic device, according to an embodiment of the disclosure;

FIG. 2 is a block diagram illustrating a configuration of an electronic device according to an embodiment of the disclosure;

FIG. 3 is a sequence diagram illustrating a method of providing button mapping information by a system including an electronic device and an external input device, according to an embodiment of the disclosure;

FIG. 4 is a diagram illustrating a method of mapping buttons between an existing input device and an external input device, according to an embodiment of the disclosure;

FIG. 5 is a diagram illustrating button mapping information according to the type of external input device, according to an embodiment of the disclosure;

FIGS. 6A to 6C are diagrams illustrating an embodiment of providing button mapping information, according to an embodiment of the disclosure;

FIGS. 7 and 8 are diagrams illustrating various embodiments of providing button mapping information, according to various embodiments of the disclosure, and

FIG. 9 is a flowchart illustrating a method for controlling an electronic device according to an embodiment of the disclosure.

### DETAILED DESCRIPTION

It should be appreciated that various embodiments of the disclosure and the terms used therein are not intended to limit the technological features set forth herein to particular embodiments of the disclosure and include various changes, equivalents, or replacements for a corresponding embodiment.

In relation to the descriptions of the drawings, like reference numerals may be used for similar or related components.

The singular form of a noun corresponding to an item may include one or more items unless clearly referred to contextually differently.

As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. For example, the term “A or B”, “at least one of A and B”, or “at least one of A or B” may refer to all of the case (1) where at least one A is included, the case (2) where at least one B is included, or the case (3) where both of at least one A and at least one B are included.

As used herein, such terms as “1^{st}” and “2^{nd}”, or “first” and “second” may be used to simply distinguish a corresponding component from another, and does not limit the components in other aspect (e.g., importance or order).

It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

In the present specification, it is to be understood that the terms, such as “including” or “having,” etc., are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added. Also, throughout the specification, “on” means to be located above or below a target portion and does not necessarily mean to be located on the upper side with respect to the direction of gravity.

When a component is “connected,” “coupled,” “supported,” or “in contact” with another component, this includes not only a case in which the components are directly connected, coupled, supported, or in contact, but also a case in which the components are indirectly connected, coupled, supported, or in contact through a third component.

When it is mentioned that a component is located “on” another component, this mention includes a case in which an element comes in contact with another element and a case in which still another element is present between both elements.

The term “and/or” includes any component of a plurality of related described components or a combination of a plurality of related described components.

The expression “a device configured to” may mean that the device is “capable of” operating together with another device or other components. For example, a “processor configured to perform A, B, and C” may mean a dedicated processor (e.g., an embedded processor) for performing a corresponding operation or a generic-purpose processor (e.g., a central processing unit (CPU) or an application processor) which may perform corresponding operations by executing one or more software programs which are stored in a memory device.

In the description, the word “module” or “unit” refers to a software component, a hardware component, or a combination thereof, which is capable of carrying out at least one function or operation. A plurality of modules or units may be integrated into at least one module and implemented using at least one processor except for those modules or units that need to be implemented in specific hardware.

Meanwhile, various elements and regions in the drawings are schematically drawn. Therefore, the technical concept of the disclosure is not limited by a relative size or spacing drawn in the accompanying drawings.

Hereinafter, embodiments of the disclosure will be described more fully hereinafter with reference to the accompanying drawings.

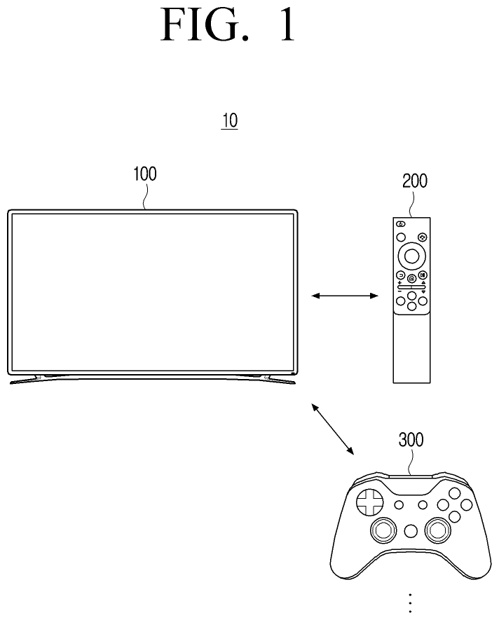

FIG. 1 is a diagram illustrating a system including an electronic device and a plurality of input devices for controlling the electronic device, according to an embodiment of the disclosure. As shown in FIG. 1, a system 10 may include an electronic device 100, an existing input device 200, and an external input device 300.

The electronic device 100 may be implemented as a television (TV). For example, the electronic device 100 may be a light emitting diode (LED) TV, an organic light emitting diode (OLED) TV, a quantum dot light emitting diode (QLED) TV, a quantum dot TV, or a digital signage device (e.g., an LED display module arranged singly or in a matrix). In addition, the electronic device 100 may be a TV having a flat screen, a curved TV having a screen with a fixed curvature, or a variable-curvature TV with a changeable curvature. However, although the electronic device 100 may be implemented as a television, this is only an example, and the electric device 100 may be implemented as an electronic device, such as a game console, a set-top box, a refrigerator, an air-conditioner, etc.

The existing input device 200 is an input device for controlling the electronic device 10, and may be an input device included with the electronic device 100 when the electronic device 100 is sold. Here, the existing input device 200 may be an input device optimized by the manufacturer of the electronic device 100 for controlling the electronic device 100. The existing input device 200 may be referred to as a first input device.

The external input device 300 is an input device for controlling an electronic device other than the electronic device 100. Here, buttons included in the external input device 300 may be different from the buttons included in the existing input device 200 in layout, number, etc. The external input device 300 may be referred to as a second input device.

However, when the electronic device 100 and the external input device 300 are paired, the external input device 300 may operate as an input device for controlling the electronic device 100. In particular, the electronic device 100 may acquire button mapping information between the external input device 300 and the existing input device 200 based on the information about the external input device 300 and provide the acquired button mapping information to the user. As a result, even if the existing input device 200 is lost or broken down, the user may more easily and intuitively control the electronic device 100 through the external input device 300.

A method by which the electronic device 100 acquires and provides button mapping information is described in detail below with reference to the drawings.

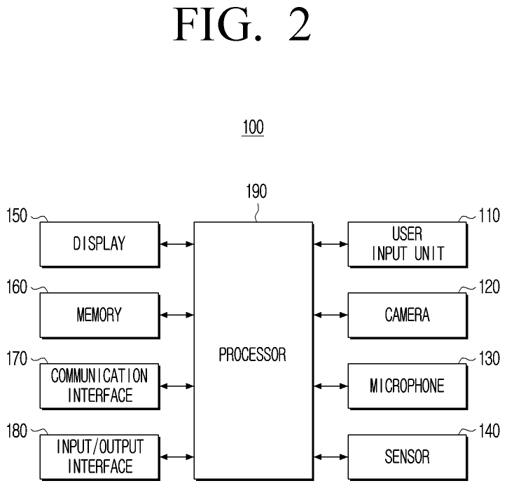

FIG. 2 is a block diagram illustrating a configuration of an electronic device according to this embodiment of the disclosure. As shown in FIG. 2, the electronic device 100 according to various embodiments of the disclosure may include a user input unit 110, a camera 120, a microphone 130, a sensor 140, a display 150, a memory 160, a communication interface 170, and a processor 190. However, this is only an example, and some components may be removed or added depending on the type of electronic device 100. For example, when the electronic device 100 is implemented as a set-top box, the electronic device 100 may not include the display 150.

The user input unit 110 may include a button, a lever, a switch, and a touch-type interfaces. Here, the touch-type interface may be implemented in a manner of receiving input through the user's touch on a screen of the display 150 of the electronic device 100. In particular, the user input unit 110 may acquire a user input for performing pairing with the external input device 300.

The camera 120 may capture still images and moving images. The camera 120 according to various embodiments of the disclosure may include one or more lenses, an image sensor, an image signal processor, and a flash. The one or more lenses may include a telephoto lens, a wide angle lens, and a super wide angle lens disposed on a surface of the electronic device 100 and may include a three dimensional (3D) depth lens. The camera 120 may be disposed on the surface (e.g., back or front) of the electronic device 100, but is not limited thereto, and various embodiments according to the disclosure may be implemented through connection to the camera 120 that exists separately outside the electronic device 100.

In particular, the camera 120 may acquire an image of the external input device 300 by imaging the external input device 300.

The microphone 130 may refer to a device that detects sound and converts the sound into an electrical signal. For example, the microphone 130 may detect voice in real time and convert the detected voice into an electrical signal, and the electronic device 100 may perform an operation corresponding to the electrical signal. The microphone 130 may include a text-to-speech (TTS) module or a speech-to-text (STT) module.

The microphone 130 may be included not only as a component of the electronic device 100, but also as a component of the existing input device 200 or the external input device 300.

Specifically, the microphone 130 may detect a voice for pairing with the external input device 300 and control the communication interface 170 to convert the voice including a user command into an electrical signal so that the electronic device 100 may perform pairing with the external input device 300.

The sensor 140 may detect a state of the electronic device 100 (e.g., movement) or an external environmental state (e.g., a user state) and generate an electrical signal or data value corresponding to the detected state. The sensor 140 may include, for example, a gesture sensor or an acceleration sensor.

The sensor 140 may include a gesture sensor, and the electronic device 100 may detect a preset user gesture for generating a floor plan image and perform a floor plan image generating operation.

The display 150 may include various types of display panels, such as a liquid crystal display (LCD) panel, an organic light emitting diode (OLED) panel, an active-matrix organic light-emitting diode (AM-OLED), a liquid crystal on silicon (LcoS), a quantum dot light-emitting diode (QLED) and digital light processing (DLP), a plasma display panel (PDP), an inorganic LED panel, and a micro LED panel, but is not limited thereto Meanwhile, the display 150 may configure a touch screen together with a touch panel or may be formed of a flexible panel.

The display 150 may display an image corresponding to the external input device 300. The display 150 may provide button mapping information using an image corresponding to the external input device 300. For example, the display 150 may display a guide message explaining a function of a button on an image corresponding to the external input device 300.

The memory 160 may store an operating system (OS) for controlling the overall operation of the components of the electronic device 100 and instructions or data related to the components of the electronic device 100. In particular, the memory 160 may include a plurality of modules for acquiring button mapping information of the external input device 300 and providing the acquired button mapping information. In particular, when the function of pairing with the external input device 300 is executed, the electronic device 100 may load data for various modules stored in a non-volatile memory to perform various operations into a volatile memory. Here, loading refers to an operation of fetching data stored in the non-volatile memory and storing the data in the volatile memory so that the processor 190 may access the data.

In addition, the memory 160 may store information about the paired external input device 300. In addition, the memory 160 may store button mapping information of the external input device 300.

Meanwhile, the memory 160 may be implemented as a non-volatile memory (ex: hard disk, solid state drive (SSD), flash memory), a volatile memory (may also include a memory in the processor 190), etc.

The communication interface 170 may include at least one circuit and may communicate with various types of external devices or servers. The communication interface 170 may include at least one of a Bluetooth low energy (BLE) module, a Wi-Fi communication module, a cellular communication module, a 3rd generation (3G) mobile communication module, a 4th generation (4G) mobile communication module, and a 4th generation long term evolution (LTE) communication module, and a 5th generation (5G) mobile communication module.

In particular, the communication interface 170 may perform pairing with the external input device 300. While pairing with the external input device 300, the communication interface 170 may acquire information about the external input device 300. In addition, the communication interface 170 may receive a signal corresponding to a button selected by the user from the external input device 300.

Here, the electronic device 100 may communicate with the external input device 300 through a short-range wireless communication interface (e.g., Bluetooth, Wi-Fi Direct, etc.).

An input/output interface 180 is configured to input and output at least one of audio and video signals. For example, the input/output interface 180 may be the high definition multimedia interface (HDMI), but this is only an example, and the input/output interface 180 may include a mobile high-definition link (MHL), a universal serial bus (USB), a display port (DP), a Thunderbolt, a video graphics array (VGA) port, an RGB port, a D-subminiature (D-SUB), and a digital visual interface (DVI). Depending on an implementation example, the input/output interface 180 may include a port that inputs and outputs only audio signals and a port that inputs and outputs only video signals as separate ports or may be implemented as a single port that inputs and outputs both audio signals and video signals. In particular, the electronic device 100 may acquire at least one input image through the input/output interface 180.

The processor 190 may control the electronic device 100 according to at least one instruction stored in the memory 160.

In particular, the processor 190 may include one or more processors. Specifically, one or more processors may include one or more of a central processing unit (CPU), a graphics processing unit (GPU), an accelerated processing unit (APU), a many integrated core (MIC), a digital signal processor (DSP), a neural processing unit (NPU), a hardware accelerator or a machine learning accelerator. One or more processors may control one or any combination of the other components of the electronic device and perform an operation related to communication or data processing. One or more processors may execute one or more programs or instructions stored in the memory. For example, one or more processors may perform a method according to an embodiment of the disclosure by executing one or more instructions stored in the memory.

When the method according to an embodiment of the disclosure includes a plurality of operations, the plurality of operations may be performed by one processor or by a plurality of processors. That is, when a first operation, a second operation, and a third operation are performed by the method according to an embodiment, the first operation, the second operation, and the third operation may all be performed by a first processor, and the first operation and the second operation may be performed by the first processor (e.g., a general-purpose processor) and the third operation may be performed by a second processor (e.g., an artificial intelligence-dedicated processor).

The one or more processors may be implemented as a single core processor including one core or as one or more multi-core processors including a plurality of cores (e.g., homogeneous multi-core or heterogeneous multi-core). When one or more processors are implemented as a multi-core processor, each of a plurality of cores included in the multi-core processor may include processor internal memory, such as a cache memory and an on-chip memory, and a common cache shared by the plurality of cores may be included in the multi-core processor. In addition, each of the plurality of cores (or some of the plurality of cores) included in the multi-core processor may independently read and execute a program instruction for implementing the method according to an embodiment of the disclosure, and all (or some) of the plurality of cores may be linked to read and perform a program instruction for implementing the method according to an embodiment of the disclosure.

When the method according to an embodiment of the disclosure includes a plurality of operations, the plurality of operations may be performed by one of the plurality of cores included in the multi-core processor or may be performed by the plurality of cores. For example, when the first operation, the second operation, and the third operation are performed by the method according to an embodiment, the first operation, the second operation, and the third operation may all be performed by a first core included in the multi-core processor, and the first operation and the second operation may be performed by the first core included in the multi-core processor and the third operation may be performed by a second core included in the multi-core processor.

In embodiments of the disclosure, the processor 190 may be a system-on-chip (SoC) in which one or more processors and other electronic components are integrated, a single-core processor, a multi-core processor, or a core included in a single-core processor or a multi-core processor, and here, the core may be implemented as a CPU, a GPU, an APU, an MIC, a DSP, an NPU, a hardware accelerator, or a machine learning accelerator, but embodiments of the disclosure are not limited thereto.

In particular, by executing at least one instruction, the processor 190 acquires information about the external input device 300 from the external input device through the communication interface 170, while performing pairing with the external input device 300. Here, the information about the external input device 300 may include at least one of a device name and a device type of the external input device 300.

The processor 190 acquires button mapping information between the existing input device 200 of the electronic device 100 and the external input device 300 based on the information about the external input device. Here, the button mapping information may be information stored by mapping the information about buttons included in the external input device 300 and functions of buttons included in the existing input device 200.

Specifically, the processor 190 may acquire button information of the external input device 300 using the information about the external input device 300. In an embodiment, the processor 190 may acquire the button information of the external input device 300 by searching a pre-built database using at least one of the device name and device type of the external input device 300 or through a web search. Here, the button information of the external input device 300 may include information about at least one of a layout of the buttons included in the external input device 300, a function of the buttons, a button operation method, the number of buttons, and a signal corresponding to the button.

In addition, the processor 190 may acquire button mapping information by comparing the button information of the external input device 300 with the button information of the existing input device 200. In an embodiment, the processor 190 may map buttons that perform the same function or have the same operation method among buttons included in the external input device 300 and buttons included in the existing input device 200. In an embodiment, when the number of buttons of the external input device 300 is smaller than the number of buttons of the existing input device 200, the processor 190 may map a plurality of operation methods for the buttons of the external input device 300 and the buttons of the existing input device 200.

The processor 190 controls the display 150 to display an image corresponding to the external input device 300 acquired based on the information about the external input device 300. In an embodiment, the processor 190 may generate an image corresponding to the external input device 300 using the image of the external input device 300 and the layout of the buttons included in the external input device 300.

The processor 190 may provide button mapping information using an image corresponding to the external input device displayed on the display 150. In an embodiment, when one of the buttons included in the external input device 300 is selected while the image corresponding to the external input device 300 is displayed, the processor 190 may receive a signal corresponding to the button selected through the communication interface 170. The processor 190 may control the display 150 to display a guide message for explaining a function of the selected button on the image corresponding to the external input device 300 based on the received signal. In an embodiment, the processor 190 may control the display 150 to display the image corresponding to the external input device 300 and the image of the existing input device. The processor 190 may provide button mapping information by connecting mapped buttons among the buttons included in the image corresponding to the external input device 300 and the buttons included in the image of the existing input device 200. In an embodiment, the processor 190 may control the display 150 to display the guide message for explaining the function of the buttons included in the image corresponding to the external input device 300 together with the image corresponding to the external input device 300.

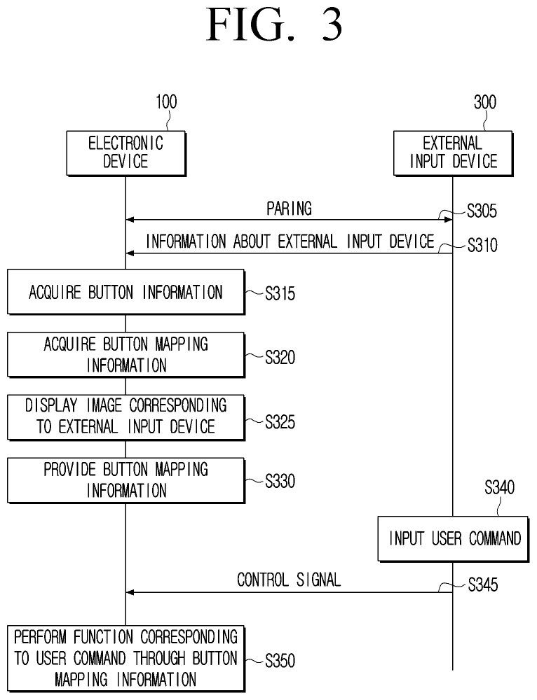

FIG. 3 is a sequence diagram illustrating a method in which a system including an electronic device and an external input device provides button mapping information, according to an embodiment of the disclosure.

First, the electronic device 100 and the external input device 300 may perform pairing (S305). Here, pairing may include an initial registration process performed for communication between the electronic device 100 and the external input device 300. For example, pairing may include Bluetooth pairing. However, without being limited thereto, pairing may include an initial registration process performed for communication connection between a plurality of devices using other communication standards. Meanwhile, pairing may also be referred to as device registration. In particular, when a preset button on the external input device 300 is selected or the external input device 300 is selected from an external device search list displayed on the electronic device 100, the electronic device 100 may perform paring with the external input device 300. Meanwhile, in the embodiment described above, it is described that the electronic device 100 and the external input device 300 perform pairing, but this is only an example, and the following operations may be performed when electronic device 100 and the external input device 300 are connected.

While pairing is performed, the external input device 300 may transmit information about the external input device 300 to the electronic device 100 (S310). Specifically, while pairing is performed, the electronic device 100 may broadcast a search signal, and the external input device 300 may transmit a response signal to the electronic device 100 based on the search signal. Here, the response signal may include information about the external input device 300. However, as described above, including information about the external input device 300 in the response signal is only an example, and the information about the external input device 300 may be transmitted to the electronic device 100 through a separate signal. Here, the information about the external input device 300 may include at least one of the device type and the device name of the external input device 300, but this is only an example, and the information about the external input device 300 may include other information, such as a device product number, other electronic devices connected to the external input device 300.

The electronic device 100 may acquire button information of the external input device 300 based on the information about the external input device 300 (S315). Here, the button information of the external input device 300 may include information about at least some of the layout of the buttons included in the external input device 300, the function of the button, the button operation method, the number of buttons, and a signal (e.g., code included in the signal) corresponding to the button.

In an embodiment, the electronic device 100 may acquire button information of the external input device 300 by searching a pre-built database based on the information about the external input device 300. Here, the database may be a database that stores button information of an input device depending on the type of the input device.

In an embodiment, the electronic device 100 may acquire the button information of the external input device 300 through a web search based on the information about the external input device 300. Specifically, the electronic device 100 may perform a web search using the device name of the external input device 300 to acquire an image of the external input device 300 and acquire button layout information from the acquired image. Here, the button layout information may include information about the shape, size, and arrangement of buttons included in the external input device 300. In addition, the electronic device 100 may acquire information about a function of buttons, a button operation method, and number of buttons by analyzing the button layout information. Also, the electronic device 100 may acquire information about a signal corresponding to a button based on a signal acquired while the user selects the button included in the external input device 300.

In an embodiment, the electronic device 100 may acquire an image of the external input device 300 by imaging the external input device 300 through the camera 120. In addition, the electronic device 100 may acquire button layout information from the captured image. Here, the button layout information may include information about the shape, size, and arrangement of buttons included in the external input device 300. In addition, the electronic device 100 may acquire information about the function of the buttons, the button operation method, and the number of buttons by analyzing the button layout information. The electronic device 100 may acquire information about a signal corresponding to a button based on a signal acquired while the user selects the button included in the external input device 300.

The electronic device 100 may acquire button mapping information (S320). Specifically, the electronic device 100 may acquire button mapping information by comparing button information of the external input device 300 with button information of the existing input device 200. That is, the electronic device 100 may automatically map the buttons of the two input devices based on the button information of the external input device 300 and the button information of the existing input device 200.

In particular, the electronic device 100 may acquire button mapping information based on the functions and operation methods of buttons included in the external input device 300 and buttons included in the existing input device 200. Specifically, the electronic device 100 may map buttons that perform the same function or have the same operation method among the buttons included in the external input device 300 and the buttons included in the existing input device 200. In an embodiment, among the buttons included in the external input device 300 and the buttons included in the existing input device 200, “power button”, “selection button”, “four-way button”, “home button”, and “setting button” have the same functions, so they may be mapped to each other. Among the buttons included in the external input device 300 and the buttons included in the existing input device 200, “slide operation button” and “touch pad” have the same operation method, so they may be mapped to each other.

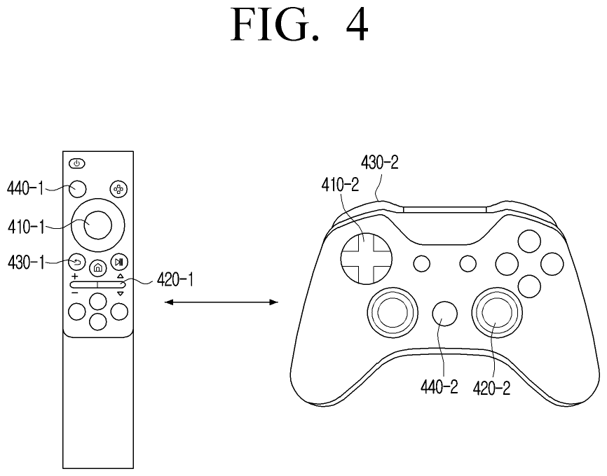

For example, as shown in FIG. 4, a first button 410-1 included in the existing input device 200 and a second button 410-2 included in the external input device 300 are four-way buttons having the same function, so they may be mapped to each other. In addition, a third button 420-1 included in the existing input device 200 and a fourth button 420-2 included in the external input device 300 are slide buttons having the same operation method, so they may be mapped to each other. In addition, a fifth button 430-1 included in the existing input device 200 and a sixth button 410-2 included in the external input device 300 are home buttons having the same function, so they may be mapped to each other. In addition, a seventh button 440-1 included in the existing input device 200 and an eighth button 440-2 included in the external input device 300 are setting buttons having the same function, so they may be mapped to each other. Meanwhile, in FIG. 4, it is explained that four buttons are mapped to each other, but this is only an example, and other buttons may also be mapped to each other using the same function and the same operation method, as described above.

In addition, when the number of buttons of the external input device 300 and the number of buttons of the existing input device 200 are different, the electronic device 100 may map a plurality of operation methods for the buttons included in the first input device to the buttons of the second input device. In an embodiment, when the number of buttons of the external input device 300 is smaller than the number of buttons of the existing input device 200, the electronic device 100 may map a plurality of operation methods for the buttons of the external input device 300 to the buttons of the existing input device 200. For example, when the number of buttons of the external input device 300 is smaller than the number of buttons of the existing input device 200, the electronic device 100 may map a first operation method (e.g., an operation method of pressing the first button once) for the first button of the external input device 300 to the second button of the existing input device 200. In addition, the electronic device 100 may map a second operation method (e.g., an operation method of double pressing multiple times or long pressing the first button) for the first button of the external input device 300 to a third button of the existing input device 200. In addition, the electronic device 100 may map a third operation method (e.g., an operation method of pressing the first and fourth buttons simultaneously) for the first and fourth buttons of the external input device 300 to a fifth button of the existing input device 200.

Conversely, if the number of buttons of the external input device 300 is greater than the number of buttons of the existing input device 200, the electronic device 100 may map a plurality of operation methods for the buttons of the existing input device 200 to a button of the external input device 300. In particular, if the external input device 300 does not support a specific operation method (e.g., a long press operation method), the electronic device 100 may map a first operation method (e.g., an operation method of pressing the first button once) for the first button of the existing input device 200 to the second button of the external input device 300 and may map a second operation method (an operation method of long pressing the first button) for the first button of the existing input device 200 to the third button of the external input device 300.

In the manner as described above, the electronic device 100 may acquire button mapping information by comparing the button information of the external input device 300 with the button information of the existing input device 200.

Meanwhile, as described above, the button mapping information may be acquired by comparing the button information of the external input device 300 with the button information of the existing input device 200, but this is only an example, and button mapping information in which the functions of the buttons of the external input device 300 depending on the type of the external input device 300 and the buttons of the existing input device 200 are mapped to each other may be stored in the electronic device 100 or an external server.

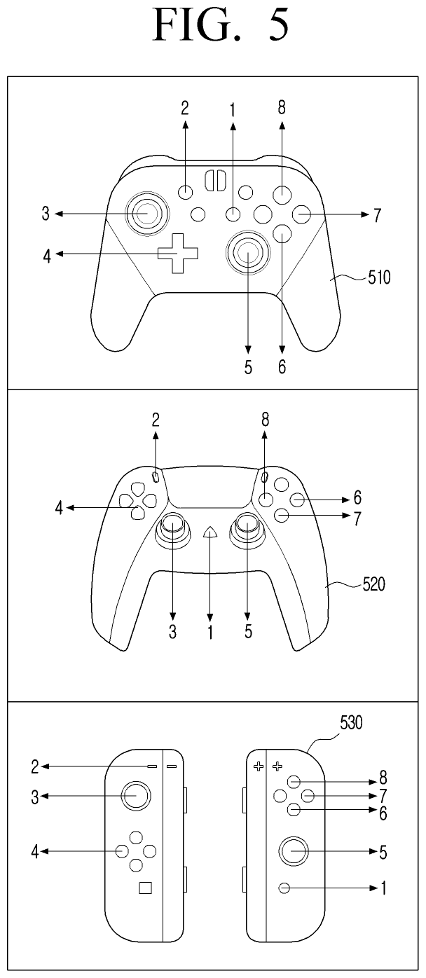

For example, as shown in FIG. 5, button mapping information for the first to third types of external input devices 510 to 530 may be pre-stored in the electronic device 100 or an external server. Here, the button mapping information for a plurality of buttons included in the first to third types of external input devices 510 to 530 may be as shown in Table 1 below.

TABLE 1

| Button | Category | Button mapping information |
|---|---|---|
| 1 | Home and Game | Smart Hub and Gaming Hub |
| | | Press and hold: Game Quick Menu |
| 2 | | Game Bar |
| 3 | Navigation | Directional Pad |
| 4 | | Directional Pad |
| 5 | | Right and Left: Channel |
| | | Up and Down: Volume |
| | | Press: Mute |
| 3 + 5 | | Press and hold: Power off |
| 8 | TV Control | setting/123/color |
| 6 | | return |
| | | Press and hold: Exit |
| 7 | | select or Play/Pause |

Accordingly, the electronic device 100 may read the button mapping information in which the functions of the buttons of the external input device 300 pre-stored in the memory 160 based on the information about the external input device 300 and the functions of the buttons of the existing input device 200 are mapped, or the electronic device 100 may transmit the information about the external input device 300 to an external server and receive button mapping information in which the functions of the buttons of the external input device 300 and the buttons of the existing input device 200 are mapped to each other from the external server.

In another embodiment, the electronic device 100 may acquire button mapping information in which the functions of the buttons of the external input device 300 and the buttons of the existing input device 200 are mapped to each other through a user input. Specifically, the electronic device 100 may display the acquired image of the external input device 300. The electronic device 100 may set a function for each of a plurality of buttons included in the image of the external input device 300 through a user input acquired based on the image of the external input device 300. Alternatively, the electronic device 100 may display the acquired image of the external input device 300 and the image of the existing input device 200 together. In addition, the electronic device 100 may acquire button mapping information in which the functions of the buttons of the external input device 300 and the buttons of the existing input device 200 are mapped to each other through a user input of mapping a plurality of buttons included in the displayed images of the two input devices to each other.

Meanwhile, in the embodiment described above, it is described that the buttons of the existing input device 200 and the buttons of the external input device 300 are mapped to each other, but this is only an example, and the electronic device 100 may acquire button mapping information by mapping a function not included in the existing input device 200 to a button of the external input device 300.

In an embodiment, the electronic device 100 may acquire button mapping information by mapping a function not included in the existing input device 200 (e.g., a function of executing an application frequently used by the user, a setting function frequently used by the user, a function of selecting an external input source (HDMI1, etc.), a function of moving to a specific channel number, an ON/OFF reservation function, etc.) to a button of the external input device 300. Here, the electronic device 100 may map functions not included in the existing input device 200 to buttons of the external input device 300 based on the user input, but this is only an example, and the electronic device 100 may provide a recommendation guide to map functions not included in the existing input device 200 to buttons of the external input device 300. The electronic device 100 may map functions not included in the existing input device 200 to buttons of the external input device 300 according to a user input acquired based on the recommendation guide.

Referring back to FIG. 3, the electronic device 100 may display an image corresponding to the external input device 300 (S325). Here, the electronic device 100 may display the image of the external input device 300 acquired based on the information about the external input device as is, but this is only an example, and an image simplifying the external input device 300 may be generated based on the image of the external input device 300 and button layout information of the external input device 300. That is, the electronic device 100 may generate a simplified image by deleting a logo or an unnecessary element (e.g., text, etc.) included in the image of the external input device 300 based on the button layout information.

The electronic device 100 may provide the button mapping information (S330). Specifically, the electronic device 100 may provide the button mapping information using the image corresponding to the external input device 300.

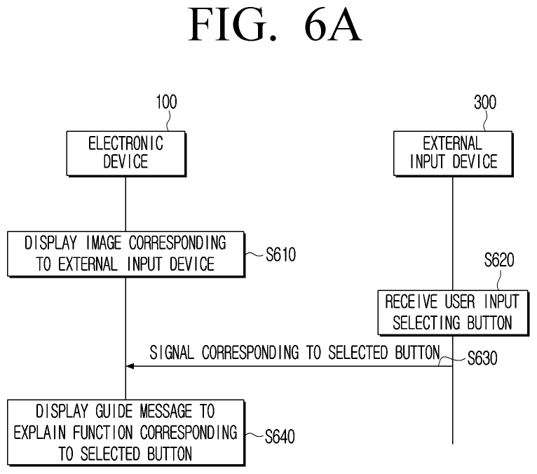

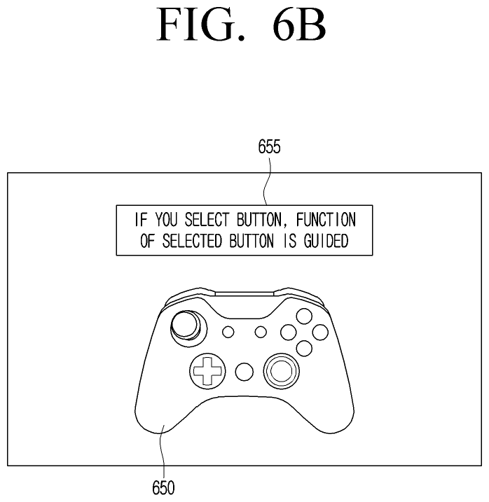

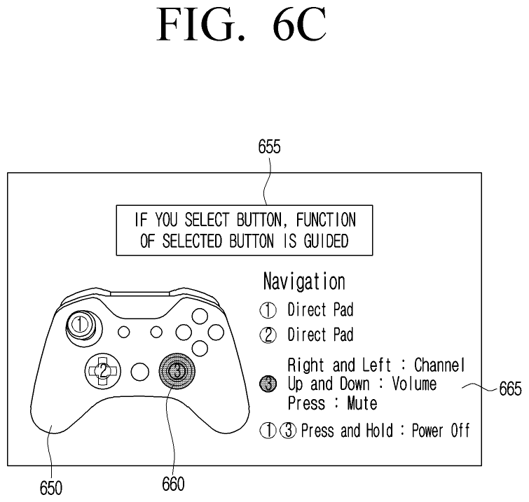

In an embodiment, when one of the buttons included in the external input device 300 is selected while the image corresponding to the external input device 300 is displayed, the electronic device 100 may receive a signal corresponding to the selected button and display a guide message to explain the function of the selected button on the image corresponding to the external input device 300 based on the received signal. This will be described with reference to FIGS. 6A to 6C.

Referring to FIG. 6A, the electronic device 100 may display an image corresponding to the external input device 300 (S610). Here, the displayed image corresponding to the external input device 300 may be an image of the external input device 300, but this is only an example, and the displayed image corresponding to the external input device 300 may be an image generated based on the image and button layout information of the external input device 300. For example, the electronic device 100 may display an image 650 corresponding to the external input device 300, as shown in FIG. 6B. Here, the electronic device 100 may display a guidance text 655 saying, “If you select button, function of selected button is guided.” together with the image 650 corresponding to the external input device 300.

The external input device 300 may receive a user input for selecting a button (S620). Specifically, the external input device 300 may receive a user input for selecting one of a plurality of buttons included in the external input device 300.

The external input device 300 may transmit a signal corresponding to the selected button (S630).

The electronic device 100 may display a guide message explaining a function corresponding to the selected button (S640). For example, when a signal corresponding to the first button is received, the electronic device 100 may display a button UI element 660 corresponding to the first button, among button UI elements included in the image 650 corresponding to the external input device 300, to be distinguished from other button UI elements as shown in FIG. 6C. That is, the electronic device 100 may highlight the button UI element 660 corresponding to the first button included in the image 650 corresponding to the external input device 300 or display the button UI element 660 in a different color or brightness. In addition, the electronic device 100 may display a guide message 665 to explain the function corresponding to the currently selected button on one side of the image 650 corresponding to the external input device 300. In addition, as shown in FIG. 6C, the electronic device 100 may display numbers on a plurality of button UI elements included in the image 650 corresponding to the external input device 300 and display the guide message 665 to explain functions of the buttons corresponding to the numbers.

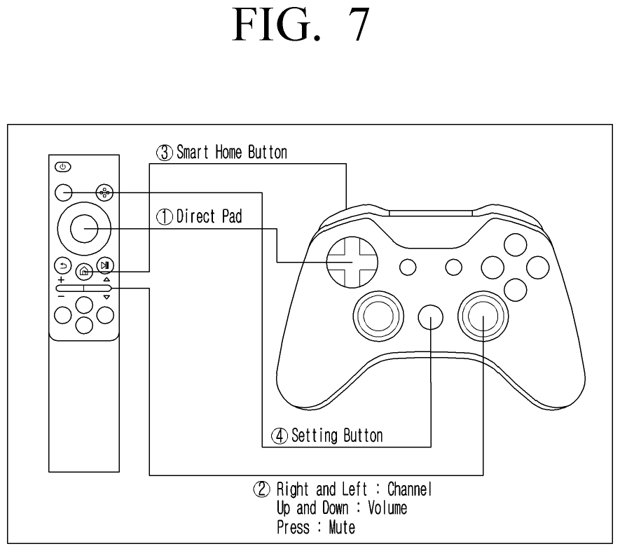

In an embodiment, the electronic device 100 may display an image corresponding to the external input device 300 and an image of the existing input device 200. In addition, the electronic device 100 may provide button mapping information by connecting mapped buttons among the buttons included in the image corresponding to the external input device 300 and the buttons included in the image of the existing input device 200. For example, as shown in FIG. 7, the electronic device 100 may provide button mapping information by connecting mapped buttons among the buttons included in the image corresponding to the external input device 300 and the buttons included in the image of the existing input device 200 and displaying information about functions that are mapped to each other on the connected lines.

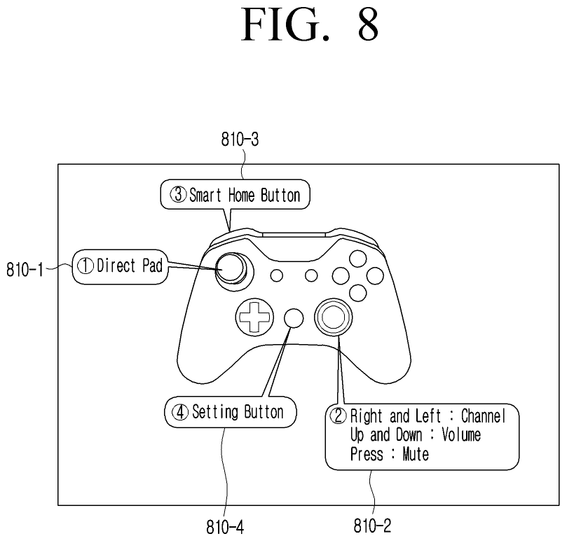

In an embodiment, the electronic device 100 may display an image corresponding to the external input device 300 and a guide message to explain the functions of buttons included in the image corresponding to the external input device 300. For example, as shown in FIG. 8, the electronic device 100 may display a guide message 810-1 to 810-4 in the form of a speech bubble to explain the function of each button included in the image corresponding to the external input device 300. Meanwhile, explaining the function of each button in the form of a speech bubble is only an example, and of course, the function of each button may be explained in other forms.

Referring back to FIG. 3, after providing (or while providing) the button mapping information, the external input device 300 may receive a user command (S340). For example, the external input device 300 may receive a user command to select one of a plurality of buttons.

The external input device 300 may transmit a control signal corresponding to the selected button to the electronic device 100 (S345).

The electronic device 100 may perform a function corresponding to a user command through the button mapping information (S350). That is, the electronic device 100 may perform the function of the electronic device 100 mapped to code included in the control signal based on the button mapping information.

As described above, by providing the button mapping information of the external input device 300, the user may more easily and intuitively control the electronic device 100 through the external input device 300 even if the existing input device 200 is lost or broken.

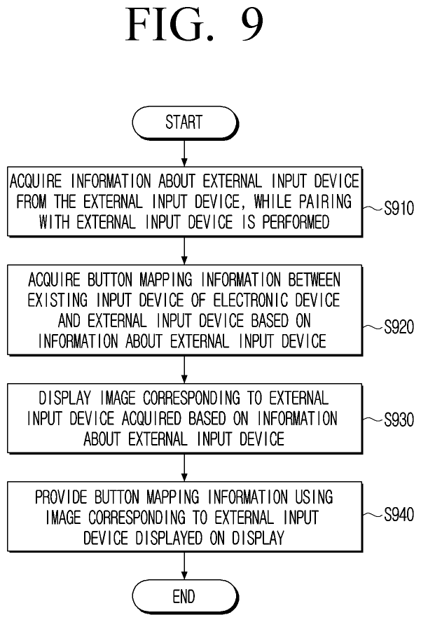

FIG. 9 is a flowchart illustrating a method for controlling an electronic device according to an embodiment of the disclosure.

First, the electronic device 100 acquires information about the external input device 300 from the external input device 300, while pairing with the external input device 300 is performed (S910). Here, the information about the external input device 300 may include at least one of a device name and a device type of the external input device 300, but is not limited thereto.

The electronic device 100 acquires button mapping information between the existing input device 200 of the electronic device 100 and the external input device 300 based on the information about the external input device 300 (S920). Specifically, the electronic device 100 may acquire button information of the external input device 300 using the information about the external input device 300. In particular, the electronic device 100 may search a pre-built database using at least one of the device name and the device type of the external input device 300 or acquire button information of the external input device 300 through a web search. Here, the button information of the external input device 300 may include information about at least one of the layout of the buttons included in the external input device 300, the function of the button, the button operation method, the number of buttons, and the signal corresponding to the button. The electronic device 100 may acquire button mapping information by comparing the button information of the external input device 300 with the button information of the existing input device 200. In an embodiment, the electronic device 100 may map buttons that perform the same function or have the same operation method among the buttons included in the external input device 300 and the buttons included in the existing input device 200. In an embodiment, when the number of buttons of the external input device 300 is smaller than the number of buttons of the existing input device 200, the electronic device 100 may map a plurality of operation methods for the buttons of the external input device 300 to the buttons of the existing input device 200.

The electronic device 100 displays an image corresponding to the external input device 300 acquired based on the information about the external input device 300 (S930). Here, the image corresponding to the external input device 300 may be the external input device 300, but is not limited thereto, and the image corresponding to the external input device 300 may be an image generated by the image of the external input device 300 and the button layout information of the external input device 300.

The electronic device 100 provides the button mapping information using the image corresponding to the external input device 300 displayed on the display 150 (S940). In an embodiment, when one of the buttons included in the external input device 300 is selected while the image corresponding to the external input device 300 is displayed, the electronic device 100 may receive a signal corresponding to the selected button and display a guide message to explain a function of the selected button on the image corresponding to the external input device 300 based on the received signal. In an embodiment, the electronic device 100 may simultaneously display the image corresponding to the external input device 300 and the image of the existing input device 200 and provide button mapping information by connecting mapped buttons among the buttons included in the image corresponding to the external input device 300 and the buttons included in the image of the existing input device 200. In an embodiment, the electronic device 100 may display a guide message to explain the functions of buttons included in the image corresponding to the external input device 300, together with the image corresponding to the external input device 300.

Meanwhile, in the embodiment described above, it is described that button mapping information is provided as a visual guide message, but this is only an example, and of course, an auditory guide message may be provided through a speaker.

Meanwhile, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product (e.g., a downloadable app) may be temporarily generated or at least temporarily stored in the machine-readable storage medium, such as memory of the manufacturer's server, a server of the application store, or a relay server.

The method according to various embodiments described above may be implemented by software including instructions that are stored in a machine (e.g. a computer) readable storage medium. The machine, which is a device capable of calling an instruction stored in the storage medium and operating according to the called instruction, may include an electronic device according to the embodiments described above.

The device-readable storage medium may be provided in the form of a non-transitory storage medium. Here, ‘non-temporary storage medium’ only means that it is a tangible device and does not contain signals (e.g., electromagnetic waves). This term does not distinguish between a case in which data is stored semi-permanently in a storage medium and a case in which data is stored temporarily. For example, a ‘non-temporary storage medium’ may include a buffer in which data is temporarily stored.

When the instruction is executed by the processor, the processor may perform a function corresponding to the instruction directly or using other components under the control of the processor. The instruction may include a code generated or executed by a compiler or an interpreter.

In the above, preferred embodiments have been illustrated and described, but the disclosure is not limited to the specific embodiments described above, and those of ordinary skill in the art pertaining to the disclosure without departing from the gist of the claims. Various modifications are possible by the disclosure, of course, and these modifications should not be individually understood from the technical spirit or perspective of the disclosure.

What is claimed is:

1. An electronic device comprising:
a display;
a memory configured to store at least one instruction; and
a processor configured to, by executing the at least one instruction:
acquire, while pairing the electronic device with an external input device is performed, information about the external input device from the external input device,
acquire button mapping information between an existing input device of the electronic device and the external input device based on the information about the external input device,
control the display to display an image corresponding to the external input device acquired based on the information about the external input device, and
control the display to display the button mapping information using the image corresponding to the external input device displayed on the display.

2. The electronic device of claim 1, wherein the processor is configured to, by executing the at least one instruction:
acquire button information of the external input device using the information about the external input device, and
acquire the button mapping information by comparing the button information of the external input device with button information of the existing input device.

3. The electronic device of claim 2, wherein
the information about the external input device includes at least one of a device name and a device type of the external input device, and
the processor is configured to, by executing the at least one instruction:
acquire the button information of the external input device by searching a pre-built database using at least one of the device name and the device type of the external input device or through a web search.

4. The electronic device of claim 2, wherein
the button information of the external input device includes information about at least one of a layout of buttons included in the external input device, functions of buttons, button operation methods, number of buttons, and signals corresponding to buttons, and
the processor is configured to, by executing the at least one instruction:
map buttons that perform a same function or buttons having a same operation method among the buttons included in the external input device and buttons included in the existing input device.

5. The electronic device of claim 4, wherein the processor is configured to, by executing the at least one instruction:
map a plurality of operation methods for the buttons included in the external input device to the buttons included in the existing input device, based on a number of the buttons included in the external input device being smaller than the number of buttons included in the existing input device.

6. The electronic device of claim 4, wherein the processor is configured to, by executing the at least one instruction:
generate the image corresponding to the external input device using an image of the external input device and the layout of the buttons included in the external input device.

7. The electronic device of claim 1, wherein
the processor is configured to, by executing the at least one instruction:
receive, based on a button selected from buttons included in the external input device while the image corresponding to the external input device is displayed, a signal corresponding to the selected button from the external input device, and
the displayed button mapping information includes a guide message to explain a function of the selected button on the image corresponding to the external input device based on the received signal.

8. The electronic device of claim 1, wherein the processor is configured to, by executing the at least one instruction:
control the display to display the image corresponding to the external input device and an image of the existing input device, and
control the display to display the button mapping information by connecting mapped buttons among buttons included in the image corresponding to the external input device and buttons included in the image of the existing input device.

9. The electronic device of claim 1, wherein
the displayed button mapping information includes a guide message to explain functions of buttons included in the image corresponding to the external input device, together with the image corresponding to the external input device.

10. The electronic device of claim 1, wherein the processor is configured to, by executing the at least one instruction:
acquire the button mapping information by mapping a function not provided by the existing input device to a button of the external input device based on a user input.

11. A method for controlling an electronic device, the method comprising:
acquiring, while pairing the electronic device with an external input device is performed, information about the external input device from the external input device,
acquiring button mapping information between an existing input device of the electronic device and the external input device based on the information about the external input device,
displaying an image corresponding to the external input device acquired based on the information about the external input device, and
displaying the button mapping information using the displayed image corresponding to the external input device.

12. The method of claim 11, wherein
the acquiring of the button mapping information includes
acquiring button information of the external input device using the information about the external input device and
acquiring the button mapping information by comparing the button information of the external input device with button information of the existing input device.

13. The method of claim 12, wherein
the information about the external input device includes at least one of a device name and a device type of the external input device, and
the acquiring of the button mapping information includes acquiring the button information of the external input device by searching a pre-built database using at least one of the device name and the device type of the external input device or through a web search.

14. The method of claim 12, wherein
the button information of the external input device includes information about at least one of a layout of buttons included in the external input device, functions of buttons, button operation methods, number of buttons, and signals corresponding to buttons, and
the acquiring of the button mapping information includes mapping buttons that perform a same function or buttons having a same operation method among the buttons included in the external input device and buttons included in the existing input device.

15. The method of claim 14, wherein the acquiring of the button mapping information includes mapping a plurality of operation methods for the buttons included in the external input device to the buttons included in the existing input device, based on a number of the buttons included in the external input device being smaller than a number of buttons included in the existing input device.
